(19) United States
(12) Patent Application Publication
(10) Pub. No.: US 2023/0106085 A1
(43) Pub. Date: Apr. 6, 2023

(54) WIRELESS CHARGE COIL

(71) Applicant: HAESUNG DS CO., LTD., Gyeongsangnam-do (KR)

(72) Inventors: Sang Hak LEE; Ki Min LEE, Seoul (KR); Dong Hyuk LEE, Seoul (KR)

(21) Appl. No.: 17/930,745

(22) Filed: Sep. 9, 2022

(30) Foreign Application Priority Data
Oct. 6, 2021 (KR) 10-2021-0132714
Mar. 11, 2022 (KR) 10-2022-0030942

(51) Int. Cl. H02J 50/10; H02J 50/00; H04B 5/00; H01F 41/04

(52) U.S. Cl. CPC H02J 50/10; H01F 41/046; H02J 50/005; H04B 5/0037

(57) ABSTRACT

According to one or more embodiments, a wireless charge coil for wireless charging of a portable terminal includes an installation member, and a conducting wire portion arranged at the installation member, wherein the conducting wire portion comprises a conductor and a magnetic material plating layer arranged on at least one surface of the conductor, and wherein the magnetic material plating layer has a thickness of about 1 µm to about 8 µm.

### CROSS-REFERENCE TO RELATED APPLICATIONS

This application is based on and claims priority under 35 U.S.C. §119 to Korean Patent Application Nos. 10-2021-0132714 filed on Oct. 6, 2021 and 10-2022-0030942 filed on Mar. 11, 2022, in the Korean Intellectual Property Office, the disclosures of which are incorporated by reference herein in their entirety.

### BACKGROUND

### 1. Field

One or more embodiments relates to a wireless charge coil.

### 2. Description of the Related Art

Recently, charging systems using a method of transmitting power wirelessly have been actively developed. In particular, a wireless charging system is commonly embedded in portable terminals such as a mobile phone, a notebook, etc.

Among design factors of a wireless charge coil, a quality factor is a key factor related to wireless charging efficiency. The higher the quality factor is, the higher the wireless charging efficiency may be. Accordingly, many efforts have been made to increase the quality factor.

As shown in the following Equation 1, as a quality factor Q is proportional to an inductance L and inversely proportional to an AC(alternating current) resistance R_{AC}, increasing the quality factor Q by reducing the AC resistance R_{AC} may be considered.

$$Q = \frac{2 π \text{} f L}{{R}_{A C}}$$

Here, f represents a usable frequency, L represents a coil inductance, and R_{AC} represents an AC resistance.

The AC resistance R_{AC} of a wireless charge receiver antenna may be represented as the following [Equation 2].

$${R}_{A C} = {R}_{D C} \left[1 + {Y}_{s +} {Y}_{p}\right]$$

Here, R_{DC} represents a DC(direct current) resistance, Ys represents a resistance component due to skin effects, and Yp represents a resistance component due to proximity effects.

Accordingly, to increase the quality factor Q by reducing the AC resistance R_{AC}, the direct current resistance R_{DC}, the skin effect resistance component Ys, and the proximity effect resistance component Yp need to be reduced.

Here, the skin effect refers to the effect that in a coil in which an alternating current flows, the alternating current does not flow evenly on a cross-section of the coil, i.e., little or no alternating current flows at the center portion of the coil while a large amount of alternating current flows at the periphery of the coil. As illustrated in FIG. 1A, when an alternating current flows in a coil 1, as a current density J does not exist at the center portion of the coil 1 but is distributed at the periphery of the coil 1, the alternating current may not flow at the center portion of the coil 1 but only flow at the periphery of the coil 1.

The proximity effect may refer to the effect that when an alternating current flows in adjacent coils, a current density of the alternating current flowing in the coils is concentrated at one side. Such proximity effect may become severe when a frequency is high and a distance between the adjacent coils is smaller. As illustrated in FIG. 1B, when an alternating current flows in adjacent coils 3 and 5, the current density J of each of the coils 3 and 5 may be distributed to areas of the coils 3 and 5 away from each other but not distributed to areas of the coils 3 and 5 adjacent to each other. As such, when the alternating current flows in the adjacent coils 3 and 5, each of the coils 3 and 5 may be affected by not only the skin effect but also the proximity effect.

Korean Laid-Open Publication No. 10-2020-0104589 discloses a wireless charge coil with a winding portion including a divided area, the wireless charge coil having improved charging efficiency by reducing a resistance component due to the skin effect and the proximity effect.

### SUMMARY

One or more embodiments include a wireless charge coil with improved quality factor.

Additional aspects will be set forth in part in the description which follows and, in part, will be apparent from the description, or may be learned by practice of the presented embodiments of the disclosure.

According to one or more embodiments, a wireless charge coil for wireless charging of a portable terminal includes an installation member, and a conducting wire portion arranged at the installation member, wherein the conducting wire portion comprises a conductor and a magnetic material plating layer arranged on at least one surface of the conductor, and wherein the magnetic material plating layer has a thickness of about 1 µm to about 8 µm.

The conductor may include a lead frame material.

The magnetic material plating layer may be a permalloy plating layer.

One surface of the conductor may be in contact with the installation member, and the magnetic material plating layer may be arranged on remaining surface of the conductor, excluding the surface which is in contact with the installation member.

When a skin depth is δ, a width of the conductor may be 1.5δ to 4δ.

At least a part of the conductor may have a divided structure.

According one or more embodiments, a wireless charge coil for wireless charging of a portable terminal, the wireless charge coil having an overall winding shape of a donut, an internal diameter greater than or equal to 25 mm and an external diameter less than or equal to 50 mm includes an installation member, and a conducting wire portion arranged at the installation member, wherein the conducting wire portion comprises a conductor and a magnetic material plating layer arranged on at least one surface of the conductor, and wherein the conductor has a thickness of about 50 µm to about 300 µm, and the magnetic material plating layer has a thickness of about 1 µm to about 8 µm.

The conductor may include a lead frame material.

The magnetic material plating layer may be a permalloy plating layer.

One surface of the conductor may be in contact with the installation member, and the magnetic material plating layer may be arranged on a remaining surface of the conductor, excluding the surface which is in contact with the installation member.

When a skin depth is δ, a width of the conductor may be 1.5δ to 4δ.

At least a part of the conductor may have a divided structure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a diagram illustrating the skin effect;

FIG. 1B is a diagram illustrating the proximity effect in adjacent coils;

FIG. 2 is a schematic plan view illustrating a wireless charge coil according to an embodiment;

FIG. 3 is a schematic view partially illustrating a cross-section of a wireless charge coil according to an embodiment;

FIG. 4 is a schematic graph showing relation between AC resistance and a width of conductor of a wireless charge coil according to an embodiment;

FIG. 5 is a schematic view illustrating a divided structure of a wireless charge coil according to a modification example of an embodiment;

FIG. 6 is a schematic graph showing relation between a quality factor and a thickness of a magnetic material plating layer of a wireless charge coil according to an embodiment;

FIGS. 7A and 7B are diagrams illustrating a process of manufacturing a wireless charge coil according to an embodiment; and

FIG. 8 is a schematic view illustrating power transmission to a wireless charge coil according to an embodiment.

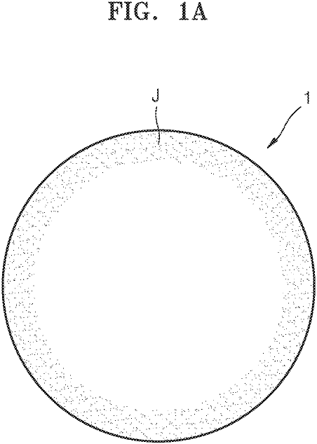

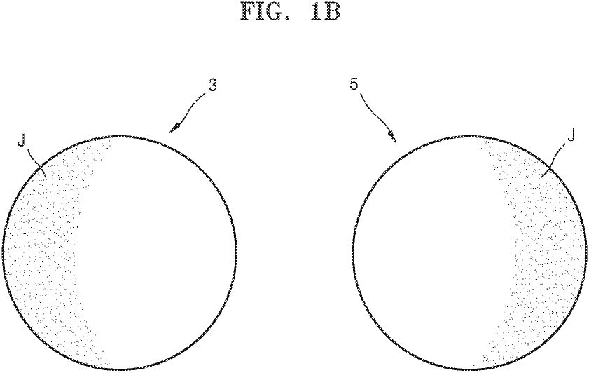

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, the disclosure according to embodiments is described in detail with reference to the accompanying drawings. In the specification and drawings, like reference numeral denote like components to omit redundant description, and sizes, ratios of length, etc. may be exaggerated to facilitate the understanding.

The disclosure may be clarified by referring to the following embodiments along with the accompanying drawings. However, the disclosure is not limited by the following embodiments and may be implemented in various forma. Rather, the embodiments are provided so that this disclosure will be thorough and complete, and will fully convey the scope of embodiments to one of ordinary skill in the art. The disclosure is defined by the scope of claims.

The terms used herein are merely used to describe the embodiments and are not intended to limit the disclosure. An expression used in the singular encompasses the expression of the plural, unless it has a clearly different meaning in the context. In the specification, it is to be understood that the terms such as “comprises” and/or “comprising” are not intended to exclude the possibility that one or more other components, steps, operations and/or elements may exist or may be added in addition to the mentioned components, steps, operations and/or elements. While such terms as “first,” “second,” “upper surface,” “lower surface,” etc., may be used to describe various components, such components must not be limited to the above terms. The above terms are used only to distinguish one component from another.

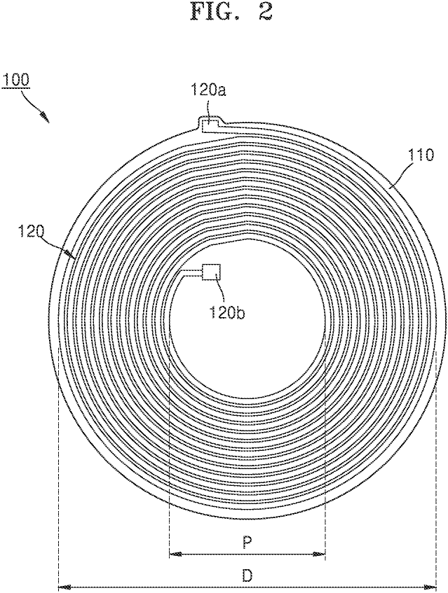

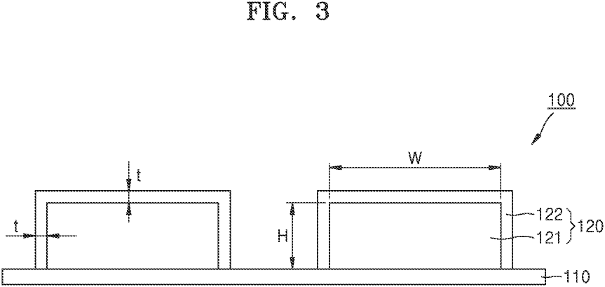

FIG. 2 is a schematic plan view illustrating a wireless charge coil according to an embodiment, and FIG. 3 is a schematic view partially illustrating a cross-section of a wireless charge coil according to an embodiment.

As illustrated in FIG. 2, a wireless charge coil 100 according to an embodiment may include an installation member 110 having a shape of a film, and a conducting wire portion 120 arranged in the installation member 110 and having a shape of a circular pattern. Terminals 120a and 120b are arranged at the ends of the conducting wire portion 120.

The installation member 110 may be an insulating substrate used when plating a magnetic material plating layer 122 and may include various materials, such as polyimide, polyurethane, etc.

The installation member 110 according to the embodiment may be an insulating substrate used when plating the magnetic material plating layer 122; however, the disclosure is not limited thereto. That is, according to the disclosure, after the plating process is completed, a substrate used in the plating process may be replaced, and a new substrate may be arranged in the wireless charge coil 100, as an installation member.

As illustrated in FIG. 3, the conducting wire portion 120 according to the disclosure may include a conductor 121 and the magnetic material plating layer 122 surrounding an upper surface and lateral surfaces of the conductor 121. That is, the conductor 121 may be in contact with the installation member 110, and the magnetic material plating layer 122 may be arranged on a remaining surface excluding the surface in contact with the installation member 110.

According to the embodiment, the magnetic material plating layer 122 may be arranged to surround the upper surface and lateral surfaces of the conductor 121; however, the disclosure is not limited thereto. That is, the magnetic material plating layer 122 according to the disclosure may surround at least one surface of the conductor 121. For example, the magnetic material plating layer 122 according to the disclosure may be arranged only on the lateral surfaces of the conductor 121.

The conductor 121 according to the embodiment may be manufactured in the shape of the circular pattern by transferring a conductive thin film through the roll-to-roll process and processing the conductive thin film through etching or punching. The conductive thin film may include various conductive materials, such as copper, alloys containing copper, gold, silver, etc., and may be in the form of rolled foil or electrolytic foil. For example, the conductor 121 may include a raw material of a lead frame.

The conductor 121 according to an embodiment may be manufactured in the shape of a circular pattern; however, the disclosure is not limited thereto. That is, no specific limitation is posed on the shape of the conductor 121 according to the disclosure. For example, as long as the conductor 121 according to the disclosure has a certain inductance allowing wireless charging, no particular limitation is posed on the shape of the conductor 121. For example, the conductor 121 according to the disclosure may have various shapes, such as a tetragonal pattern, zigzag pattern, etc.

Moreover, the conductor 121 according to the embodiment may be transferred and manufactured through the roll-to-roll process; however, the disclosure is not limited thereto. That is, the manufacturing of the conductor 121 according to the disclosure may not use the roll-to-roll process and the conductor 121 of the wireless charge coil may be manufactured by processing the conductive thin material into a conductive plate.

Hereinafter, the shape of the conductor 121 is described in detail.

A thickness H and a width W of the conductor 121 may be designed to meet an inductance L required for transmission power determined by wireless charge specifications, and may be designed considering the skin effect and the proximity effect.

The thickness H of the conductor 121 according to the embodiment may be about 50 µm to about 300 µm.

The width W of the conductor 121 according to the embodiment may be determined according to a size of external diameter D (size of diameter) of the wireless charge coil 100 and performance requirement of the inductance L and in consideration of total winding number.

According to the embodiment, a range of optimal value of the width W of the conductor 121 is determined through repeated experiments, and the optimal value range of the width W of the conductor 121 is 1.5δ to 4δ. The unit δ indicates the skin depth, and the skin depth δ is an index showing to what depth an alternating current may flow by the skin effect. The skin depth may be defined according to the following Equation 3.

$$δ = \frac{1}{\sqrt{π \text{} f \text{} μ σ}}$$

Where f represents an applied frequency, µ represents a conductor permeability, and σ represents a conductor conductivity.

For example, an operating frequency for wireless charging ranging from 100 kHz to 105 kHz defined by the Wireless Power Consortium (WPC) may be applied as the frequency f, and in this case, 1δ may be about 144 µm to about 206 µm in the case of copper material.

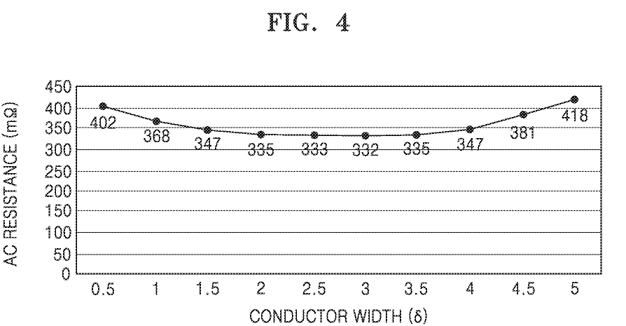

Hereinafter, with reference to the following Table 1 and FIG. 4, the critical meaning of the lowest limit of 1.5δ and the upper limit of 4δ of the thickness of the width W of the conductor 121 is described.

The determination of optimal value of the width W of the conductor 121 may be performed by using a value of AC resistance R_{AC}. That is, according to Equation 1, the smaller the value of AC resistance RAC is, the greater the quality factor Q may become, and by measuring the value of AC resistance RAC according to the width W of the conductor 121, an optimal numerical range may be obtained.

The Table 1 below is a result of calculating a value of AC resistance RAC while changing the width W of the conductor 121 through experiments when the operating frequency is 130 kHz, and FIG. 4 is a graph showing such result. An interval between the widths W of the conductor 121 is set to be 0.5δ for each specimen, and the interval of 0.5δ is designed to be narrow enough to observe the critical characteristics.

TABLE 1

| Conductor width (unit: δ) | AC resistance (mΩ) value |
|---|---|
| 0.5 | 402 |
| 1.0 | 368 |
| 1.5 | 347 |
| 2.0 | 335 |
| 2.5 | 333 |
| 3.0 | 332 |
| 3.5 | 335 |
| 4.0 | 347 |
| 4.5 | 381 |
| 5.0 | 418 |

As shown in Table 1 and FIG. 4, when the width W of the conductor 121 is 1.0δ, the value of AC resistance R_{AC} is 368 mΩ, when the width W of the conductor 121 is 1.5δ, the value of AC resistance R_{AC} is 347 mΩ, and when the width W of the conductor 121 is 2δ, the value of AC resistance R_{AC} is 335 mΩ. As for the rate of change, when the width W is changed from 1δ to 1.5δ, the value of AC resistance R_{AC} decreases by 21 mΩ, and when the width W is changed from 1.5δ to 2δ, the value of AC resistance R_{AC} decreases by 12 mΩ. Accordingly, there is a remarkable change in the operation and effects of the disclosure based on the reference width W of 1.5δ.

Furthermore, as shown in Table 1 and FIG. 4, when the width W of the conductor 121 is 3.5δ, the value of AC resistance R_{AC} is 335 mΩ, when the width W of the conductor 121 is 4δ, the value of AC resistance R_{AC} is 347 mΩ, and when the width W of the conductor 121 is 4.5δ, the value of AC resistance R_{AC} is 381 mΩ. As for the rate of change, when the width W is changed from 3.5δ to 4δ, the value of AC resistance R_{AC} increases by 12 mΩ, and when the width W is changed from 4δ to 4.5δ, the value of AC resistance R_{AC} increases by 34 mΩ. Accordingly, there is a remarkable change in the operation and effects of the disclosure based on the reference width W of 4δ.

In addition, as the value of AC resistance R_{AC} when the width W of the conductor 121 ranges from 2δ to 3.5δ is less than the value of AC resistance R_{AC} when the width W is 1.5δ and when the width W is 4δ, the range of 1.5δ to 4δ may be the optical range of the width W of the conductor 121 considering the value of AC resistance R_{AC}.

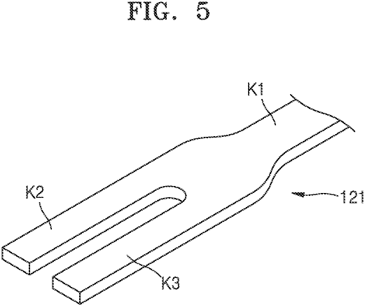

At least a part of the conductor 121 may have a divided structure. That is, as illustrated in FIG. 5, the conductor 121 may have a structure in which one line K1 is divided into two lines K2 and K3. The wireless charge coil 100 may have a conductor of divided structure as long as the wireless charge coil 100 complies with specifications requested by a user, e.g., inductance, etc., and in this case, the skin effect and the proximity effect may be reduced. The principle according to which the conductor of divided structure reduces the skin effect and the proximity effect is disclosed in Korean Laid-Open Publication No. 10-2020-0104589.

Although FIG. 5 illustrates a structure divided into two lines, the disclosure is not limited thereto. That is, according to the disclosure, no particular limitation is posed on the divided structure as long as it satisfies the inductance required for the wireless charging performance. For example, the divided structure may include three lines, four lines, etc.

The magnetic material plating layer 122 may be a permalloy plating layer including nickel and iron. The nickel content in the permalloy plating layer may be 70 % to 80 % of the total so that the magnetic material plating layer 122 has the characteristic of high permeability.

The permalloy plating is plating including nickel and iron, and the permeability may be greater than or equal to 5000. When the frequency of 100 kHz is applied, the permeability according to the permalloy composition ratio may be as shown in the following Table 2.

TABLE 2

| Permalloy composition | Permeability (µ) value |
|---|---|
| Ni 78%, Fe 22% | 8000 |
| Ni 80%, Fe 20% | 5000 |

According to the embodiment, the magnetic material plating layer 122 may be a permalloy plating layer including nickel and iron; however, the disclosure is not limited thereto. That is, according to the disclosure, the magnetic material plating layer 122 may be applied regardless of its material as long as it has the effect of electromagnetic shield. For example, the magnetic material plating layer 122 may include FeSiBCr, CoF-based soft magnetic alloy, Fe-based soft magnetic alloy, Co-based soft magnetic alloy, NiFe-based soft magnetic alloy, Ba-based ferrite, MnZn-based ferrite, NiZn-based ferrite, and NiZnCu-based ferrite.

By the shielding effect, the magnetic material plating layer 122 may reduce a resistance component Yp caused by the proximity effect between the adjacent conductors 121. That is, because the magnetic material plating layer 122 has high permeability, the electromagnetic interference effect between the neighboring conductors 121 may be reduced.

According to the embodiment, an optimal value range of a thickness t of the magnetic material plating layer 122 may be determined through repeated simulation and experiments.

That is, as for a wireless charge coil used in a portable terminal for wireless charging, the whole size thereof (diameter and thickness) is limited by specifications such as size, performance, etc. of commercial products, and the thickness, width, and winding number of the conductor 121 of the wireless charge coil 100 are determined accordingly. Hence, the thickness of the magnetic material plating layer 122 applied to the conductor 121 having such constraint condition may be determined. Specifically, the example of wireless charge coil for portable terminal suggested by the WPC may have an overall winding shape of a donut, an external diameter D less than or equal to about 50 mm, an internal diameter P greater than or equal to about 25 mm, and a winding number of about 10.

According to the embodiment, an optimal value range of the thickness of the magnetic material plating layer 122 determined through simulation and experiments considering the aforementioned conditions may be 1 µm to 8 µm.

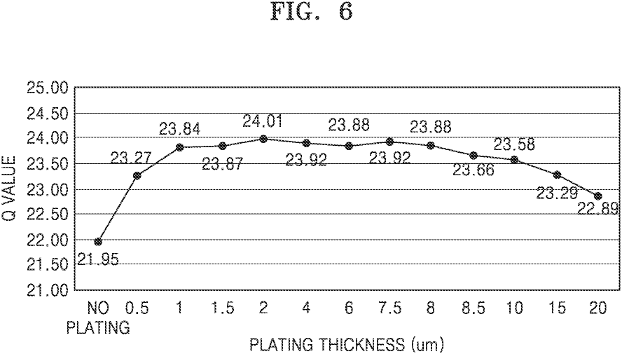

Hereinafter, with reference to the following Table 3 and FIG. 6, the critical meaning of the lowest limit of 1 µm and the upper limit of 8 µm of the thickness t of the magnetic material plating layer 122 is described.

The following Table 3 and FIG. 6 show a result of calculating the quality factor Q while changing the thickness t of the magnetic material plating layer 122 through experiments when the permalloy composition is 80% of nickel and 20% of iron. The experimental conditions are: operating frequency of 130 kHz; wire width from 0.365 mm to 0.520 mm; and center distance of adjacent wire from 0.495 mm to 0.650 mm, and the wire width is set to linearly taper off inward from the outmost side.

A minimum interval between the thicknesses t of the magnetic material plating layer 122 is set to be 0.5 µm for each specimen, and the interval of 0.5 µm is designed to be narrow enough to observe the critical characteristics.

TABLE 3

| Plating thickness (unit: µm) | Quality factor Q value |
|---|---|
| No plating | 21.95 |
| 0.5 | 23.27 |
| 1.0 | 23.84 |
| 1.5 | 23.87 |
| 2.0 | 24.01 |
| 4.0 | 23.92 |
| 6.0 | 23.88 |
| 7.5 | 23.92 |
| 8.0 | 23.88 |
| 8.5 | 23.66 |
| 10.0 | 23.58 |
| 15.0 | 23.29 |
| 20.0 | 22.89 |

As shown in Table 3 and FIG. 6, when the plating thickness t of the magnetic material plating layer 122 is 0.5 µm, the quality factor Q is 23.27, when the plating thickness t is 1 µm, the quality factor Q is 23.84, and when the plating thickness t is 1.5 µm, the quality factor Q is 23.87. As for the rate of change, when the plating thickness t is changed from 0.5 µm to 1 µm, the quality factor Q increases by 0.57, and the plating thickness t is changed from 1 µm to 1.5 µm, the quality factor Q increases by 0.03. Accordingly, there is a remarkable change in the operation and effects of the disclosure based on the reference plating thickness of 1 µm.

Moreover, as shown in Table 3 and FIG. 6, when the plating thickness t of the magnetic material plating layer 122 is 7.5 µm, the quality factor Q is 23.92, when the plating thickness t is 8 µm, the quality factor Q is 23.88, and when the plating thickness t is 8.5 µm, the quality factor Q is 23.66. As for the rate of change, when the plating thickness t is changed from 7.5 µm to 8 µm, the quality factor Q decreases by 0.04, and the plating thickness t is changed from 8 µm to 8.5 µm, the quality factor Q decreases by 0.22. Accordingly, there is a remarkable change in the operation and effects of the disclosure based on the reference plating thickness of 8 µm.

In addition, as the value of quality factor Q when the plating thickness t ranges from 1.5 µm to 7.5 µm exceeds the value of quality factor Q when the plating thickness t is 1 µm and when the plating thickness t is 8 µm, the range of 1 µm to 8 µm may be the optical range of the plating thickness t considering the value of quality factor Q.

According to the embodiment, the magnetic material plating layer 122 arranged on upper surface of the conductor 121 and the magnetic material plating layer 122 arranged on the lateral surfaces of the conductor 121 may have the same thickness; however, the disclosure is not limited thereto. That is, according to the disclosure, the thickness of the magnetic material plating layer 122 arranged on the upper surface of the conductor 121 may a thickness different than that of the magnetic material plating layer 122 arranged on the lateral surfaces of the conductor 121.

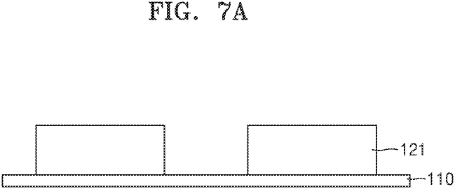

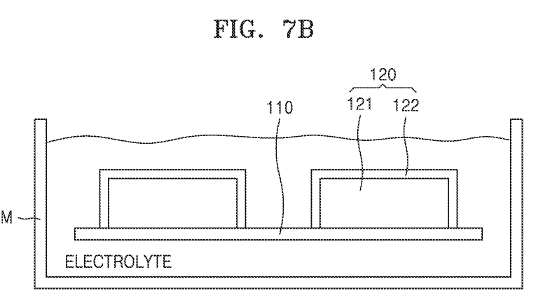

Hereinafter, the manufacturing method of the wireless charge coil 100 according to the embodiment are described with reference to FIGS. 7A and 7B.

First, as illustrated in FIG. 7A, the conductor 121 having a shape of the circular pattern may be arranged on the installation member 110 having a shape of a film.

The conductor 121 may be formed in the shape of circular pattern by processing the conductive thin material through etching, punching, etc. and attached to the installation member 110. At this time, and adhesive material may be provided between the conductor 121 and the installation member 110 to facilitate the attachment.

Then, as illustrated in FIG. 7B, the permalloy electroplating may be performed by immersing the conductor 121 and the installation member 110 into an electrolytic bath M containing an electrolyte to form the magnetic material plating layer 122 on the upper surface and lateral surfaces of the conductor 121.

As described above, as for the ratio of permalloy plating, the content of nickel may be 70% to 80% of the total. The permeability of the magnetic material plating layer 122 may be greater than or equal to 5000, and to achieve such permeability, selecting the composition, particle size, etc. of nickel may be important.

The thickness of magnetic material plating layer 122 may be 1 µm to 8 µm as described above.

According to the embodiment, the magnetic material plating layer 122 may be formed through electroplating; however, the disclosure is not limited thereto. That is, the magnetic material plating layer 122 according to the disclosure may be formed through electroless plating.

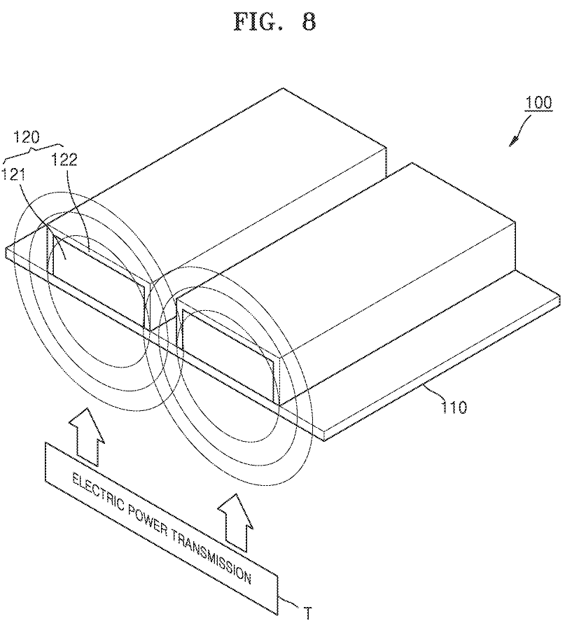

Hereinafter, the aspect of transmitting power to the wireless charge coil 100 is described with reference to FIG. 8.

As illustrated in FIG. 8, the wireless charge coil 100 of the embodiment may be used as receiver coil, and in this case, a transmitter T may be arranged to face the installation member 110.

When the transmitter T is driven, due to the electromagnetic field generated from the transmitter T, a current may be induced to the wireless charge coil 100 and charging may be performed. At this time, as the wireless charge coil 100 includes the magnetic material plating layer 122 of proper thickness, the skin effect and the proximity effect may be reduced. In such case, not only the quality factor regarding the wireless charging efficiency increases, but also the function of preventing heat generation of the wireless charge coil 100 may be improved.

The wireless charge coil 100 according to the embodiment may be used a receiver coil; however, the disclosure is not limited thereto. That is, the wireless charge coil 100 may be used limitlessly as a transmitting coil, or a receiver coil.

Although the electric power transmission and reception using the wireless charge coil 100 according to the embodiment is performed by an electromagnetic induction method, the disclosure is not limited thereto. That is, the electric power transmission and reception of the wireless charge coil 100 according to the disclosure may be applied to an electromagnetic resonance method and radio frequency (RF) wireless electric power transmission method.

As the wireless charge coil 100 according to an aspect of the disclosure includes the conducting wire portion including a magnetic material plating layer 122 having an optimal thickness, the wireless charge coil 100 may have an effect of increasing the quality factor.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

### INDUSTRIAL APPLICABILITY

The disclosure may be used in a wireless charge coil manufacturing industry, etc.

What is claimed is:

1. A wireless charge coil for wireless charging of a portable terminal, the wireless charge coil comprising:
an installation member; and
a conducting wire portion arranged at the installation member,
wherein the conducting wire portion comprises a conductor and a magnetic material plating layer arranged on at least one surface of the conductor, and
the magnetic material plating layer has a thickness of about 1 µm to about 8 µm.

2. The wireless charge coil of claim 1, wherein the conductor includes a lead frame material.

3. The wireless charge coil of claim 1, wherein the magnetic material plating layer is a permalloy plating layer.

4. The wireless charge coil of claim 1, wherein one surface of the conductor is in contact with the installation member, and the magnetic material plating layer is arranged on a remaining surface of the conductor, excluding the surface which is in contact with the installation member.

5. The wireless charge coil of claim 1, wherein, when a skin depth is δ, a width of the conductor is 1.5δ to 4δ, and
the skin depth δ satisfies the following equation:
$$δ = \frac{1}{\sqrt{π \text{} f \text{} μ σ}}$$
where f represents an applied frequency, µ represents a conductor permeability, and σ represents a conductor conductivity.

6. The wireless charge coil of claim 1, wherein at least a part of the conductor has a divided structure.

7. A wireless charge coil for wireless charging of a portable terminal, the wireless charge coil having an overall winding shape of a donut, an internal diameter greater than or equal to about 25 mm and an external diameter less than or equal to about 50 mm, and comprising:
an installation member; and
a conducting wire portion arranged at the installation member,
wherein the conducting wire portion comprises a conductor and a magnetic material plating layer arranged on at least one surface of the conductor, and
wherein the conductor has a thickness of about 50 µm to about 300 µm, and
the magnetic material plating layer has a thickness of about 1 µm to about 8 um.

8. The wireless charge coil of claim 7, wherein the conductor includes a lead frame material.

9. The wireless charge coil of claim 7, wherein the magnetic material plating layer is a permalloy plating layer.

10. The wireless charge coil of claim 7, wherein one surface of the conductor is in contact with the installation member, and
the magnetic material plating layer is arranged on a remaining surface of the conductor, excluding the surface which is in contact with the installation member.

11. The wireless charge coil of claim 7, wherein, when a skin depth is δ, a width of the conductor is 1.5δ to 4δ, and
the skin depth δ satisfies the following equation:
$$δ = \frac{1}{\sqrt{π \text{} f \text{} μ σ}}$$
where f represents an applied frequency, µ represents a conductor permeability, and σ represents a conductor conductivity.

12. The wireless charge coil of claim 7, wherein at least a part of the conductor has a divided structure.
